(19) United States
(12) Patent Application Publication
(10) Pub. No.: US 2008/0075905 A1
(43) Pub. Date: Mar. 27, 2008

(54) Adhesive segment kit

(76) Inventor: Bradley Siegal, Buffalo Grove, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/528,194

(22) Filed: Sep. 26, 2006

(51) Int. Cl. B32B 33/00

(52) U.S. Cl. 428/40.1

(57) ABSTRACT

A kit of dispensable adhesive members including a plurality of carrier member pairs, a plurality of segments having adhesive on opposite sides thereof, and a closable container. The carrier members of each pair each have a release surface on one side with at least one of the carrier members being flexible, and one carrier member of the pair has a different length or width than the other carrier member of the pair. Each segment on its opposite sides is adhered to the release surfaces of a carrier member pair. The container carries the plurality of carrier member pairs and plurality of segments, and permits selective dispensing of one segment and carrier member pair therefrom.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to adhesive dots, and more particularly to kits for dispensing adhesive segments according to use requirements.

### BACKGROUND OF THE INVENTION AND TECHNICAL PROBLEMS POSED BY THE PRIOR ART

Adhesives are, obviously, used to adhere two different pieces together in many different applications. Such adhesives are often applied to one or both of the pieces from a dispenser, such as a glue bottle.

However, in many applications, dispensing the adhesive from a bulk container is not suitable. For example, if the adhesive requires drying before being effective, the time required for such drying may be unacceptable. Further, in some applications a specific amount and/or area of adhesive may be desired, which cannot be reliably dispensed from a bulk container. In these and other cases, adhesive dots are sometimes satisfactorily used, with an individual dot being applied to adhere to one piece and the second piece then applied to the exposed surface of the dot, whereby the dot is adhered on opposite sides to the two pieces to bridge between the two and secure the pieces together. However, such adhesive dots are understandably difficult to handle in bulk before being applied, as they will adhere to most surfaces, and each other, before being used if not handled properly.

One structure which has been used to handle adhesive dots prior to dispensing for use is disclosed in U.S. Pat. Nos. 5,935,670, 6,319,442 and 6,686,016. In that structure, dots are spaced along an elongated carrier strip which is then rolled up in a coil and placed in a dispensing container. In the coil, each spaced adhesive dot is adhered on its radially inner side to one section of the strip and on its outer side to the opposite side of the strip (i.e., the portion of the strip which is, in the coil, wrapped over the top of the adhesive dot). The underlying surface of the strip is manufactured so as to have less release than its opposite side so that when the strip is uncoiled, the overlying portion of the strip will peel off of the adhesive dot and leave it adhered to the underlying strip, thereby exposing the dots on the outermost coil. Unfortunately, there are several drawbacks to this structure. It necessarily results in multiple exposed adhesive dots around the outer surface, even if only one adhesive dot is required at that time. Those outer exposed adhesive dots are thus susceptible to being dislodged and/or damaged (including, e.g., having dirt and dust stick to the exposed side before they are used, causing their stickiness to be undesirably reduced). Further, this structure requires careful selection of release characteristics to both surfaces of the carrier strip. Not only must the inner surface of the coiled strip (wrapped over the outer side of the adhesive dots) have greater release than the outer surface of the inner portion of the strip beneath the dots (so that the adhesive dots remain on the inner strip portion as it is uncoiled as already mentioned), but the outer surface of the coiled strip, which must hold the adhesive dots, must itself also provide greater release than the piece to which it is to be applied (otherwise, the adhesive dot will not come off of the strip when it is intended to be stuck to the piece). Thus, three different amounts of release must be accounted for.

The present invention is intended to overcome, inter alia, one or more of the above problems.

### SUMMARY OF THE INVENTION

In one aspect of the present invention, a kit of dispensable adhesive members is provided, including a plurality of carrier member pairs, wherein the carrier members of each pair each have a release surface on one side and at least one of the carrier members is flexible. A plurality of segments have adhesive on opposite sides thereof, and each segment on its opposite sides is adhered to the release surfaces of a carrier member pair. A closable container carries the plurality of carrier member pairs and plurality of segments, and permits selective dispensing of one segment and carrier member pair therefrom.

In one form of this aspect of the present invention, the carrier member pairs each comprise a single carrier having a release surface on one side. The single carrier is folded along a line where the one carrier member of the pair is the single carrier on one side of the fold line and the other carrier member of the pair is the single carrier on the other side of the fold line. In a further form, the fold line is spaced from a parallel center line of the single carrier.

In another form of this aspect of the present invention, one carrier member of a pair is larger than the other carrier member of the pair.

In still another form of this aspect of the present invention, the container includes a resealable closure.

In yet another form of this aspect of the present invention, the segment is thermoplastic hot melt adhesive.

In another aspect of the present invention, a kit of dispensable adhesive members is provided, including a plurality of carrier member pairs, a plurality of segments having adhesive on opposite sides thereof, and a closable container. The carrier members of each pair each have a release surface on one side with at least one of the carrier members being flexible, and have a width and a length, wherein one carrier member of the pair has a different length or width than the other carrier member of the pair. Each segment on its opposite sides is adhered to the release surfaces of a carrier member pair. The container carries the plurality of carrier member pairs and plurality of segments, and permits selective dispensing of one segment and carrier member pair therefrom.

In one form of this aspect of the present invention, the carrier member pairs each comprise a single carrier having a release surface on one side and folded along a line whereby the one carrier member of the pair is the single carrier on one side of the fold line and the other carrier member of the pair is the single carrier on the other side of the fold line. In a further form, the single carrier is an elongated rectangle and the fold line is parallel to spaced opposite sides of the elongated rectangle, with the fold closer to one of the spaced opposite sides than to the other of the spaced opposite sides.

In another form of this aspect of the present invention, the container includes a resealable closure.

In still another form of this aspect of the present invention, both of the carrier members of each pair are flexible.

In yet another form of this aspect of the present invention, the segment is thermoplastic hot melt adhesive.

In a still further form of this aspect of the present invention, the carrier members are rectangular.

### BRIEF DESCRIPTION OF THE DRAWINGS

FIG. 1 is a perspective view of an adhesive segment and carrier according to one embodiment of the present invention;

FIG. 2 is a perspective view of the FIG. 1 embodiment illustrating the adhesive segment being exposed from the carrier for use;

FIG. 3 is a perspective view illustrating the removal of an exposed adhesive segment from the carrier;

FIG. 4 is a view similar to FIG. 2 showing the adhesive segment being fully exposed;

FIG. 5 is a perspective view illustrating an alternate method of removing an exposed segment and applying the segment to another surface;

FIG. 6 is a perspective view of a second embodiment of the present invention;

FIG. 7 is a perspective view illustrating the removal of an exposed adhesive segment from the FIG. 6 carrier;

FIG. 8 is a perspective view illustrating exposing an adhesive segment of the second embodiment;

FIG. 9 is a perspective view illustrating an alternate method of removing the FIG. 8 exposed segment and application of the segment to another surface;

FIG. 10 is a perspective view of an adhesive segment and carrier according to a third embodiment of the present invention;

FIG. 11 is a perspective view of the FIG. 10 embodiment illustrating the adhesive segment being exposed from the carrier for use; and

FIG. 12 is a perspective view of a kit of dispensable adhesive segments according to the present invention.

### DETAILED DESCRIPTION OF THE INVENTION

The present invention consists of a kit 20 (FIG. 12) of dispensable adhesive members as described below and shown in the Figures.

The kit 20 includes a plurality of carrier member pairs 30A, 30B, As illustrated in FIGS. 1-4, the carrier members 30A, 30B are each a square flexible member having a release surface on one side 32A, 32B. It should be appreciated, however, that the carrier members 30A, 30B could be other shapes including, for example, rectangular and circular.

A suitable adhesive segment 40 is located between the carrier members 30A, 30B, and secured to the facing release surfaces of each carrier member 30A, 30B. The adhesive segment 40 may be any suitable object which is adhesive on opposite sides, and may include, for example, a carrier with adhesive secured to opposite sides of the carrier, or thermoplastic hot melt adhesive (such as used to attach cards to mailing inserts). Moreover, the adhesive segment 40 may consist of a single adhesive dot, or it may consist of a pattern having a plurality of adhesive elements. Further, it should be understood that while the adhesive elements such as adhesive dots may be circular as shown in the figures, they may also be virtually any other shape as well depending upon expected uses. It should be appreciated, therefore, that the present invention may be advantageously used with any adhesive segment which has sticky or adhesive opposite sides.

It should be recognized that the carrier members 30A, 30B will protect the adhesive segment 40 after it is manufactured until it is intended to be used. Thus, the sticky opposite sides will retain their adhesive characteristics, without their stickiness being reduced as a result of dirt or dust accumulating on the surfaces.

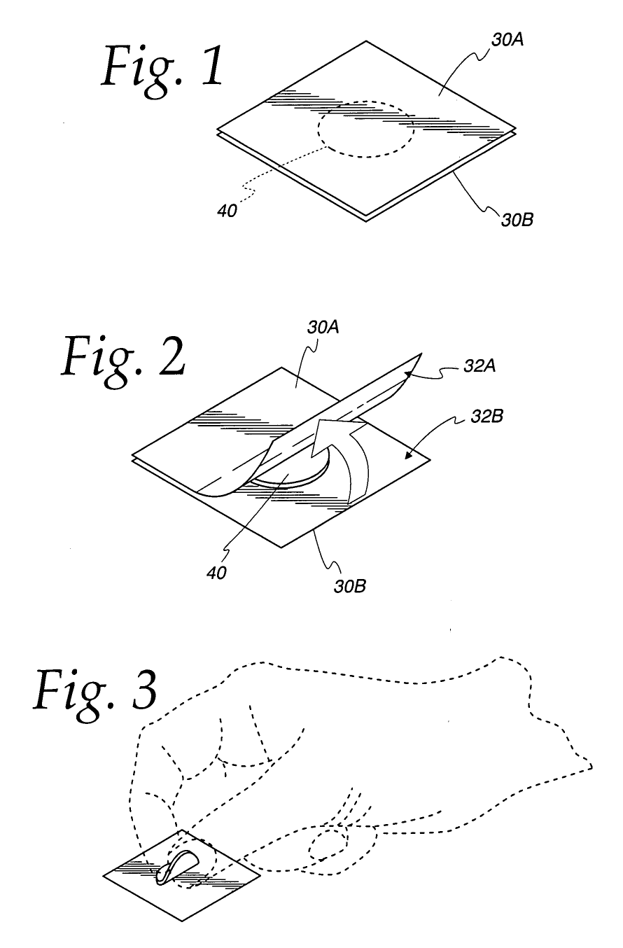

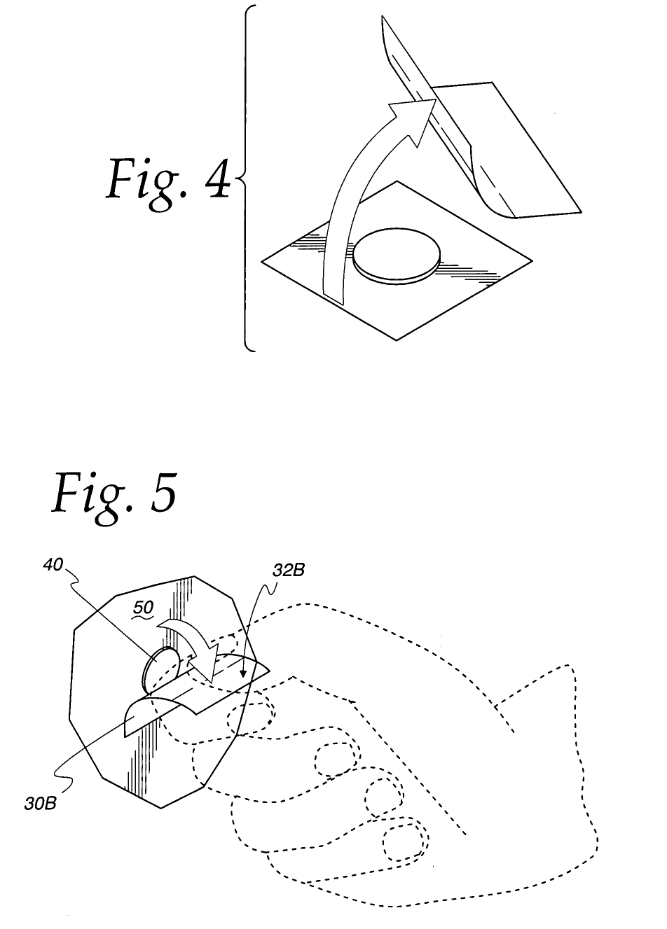

When it is desired to use an adhesive segment 40, a user may peel the two carrier members 30A, 30B apart (see, e.g., FIGS. 2 and 4). The adhesive segment 40 will remain adhered on one of the carrier members (member 30B in the illustrations), and the other surface will be exposed. The adhesive segment 40 can then either be manually removed from the one carrier member (30B) as illustrated in FIG. 3, and then manually placed where desired, or it may be carried on the one carrier member (30B) and then pressed against another surface 50 where desired (see FIG. 5), in which case when the one carrier member 30B is pulled away its release characteristics will cause the adhesive segment 40 be released and therefore adhere to the desired surface 50.

It should thus be appreciated that only one release characteristic need be provided, on the facing surfaces 32A, 32B of the carrier members 30A, 30B. The carrier members 30A, 30B can be cut from a single sheet having only one side treated for release characteristics, with the release characteristics of the other side being completely irrelevant. Moreover, for manual handling such as illustrated in FIG. 3, the only release characteristic of the surface required is that the adhesive segment 40 be removable from the surface without damaging it, while for dispensing and applying such as illustrated in FIG. 5, there is only a single relative release characteristic (i.e., that when the segment 40 is adhered on one side to the carrier member (30B) and on the other to the application surface 50, the segment 40 will stick with the application surface 50 and release from the carrier member (30B). Thus, there is no requirement that two different carrier surfaces be carefully treated to ensure that the segment will stick to a specific one of the carrier surfaces as with the coiled prior art structures.

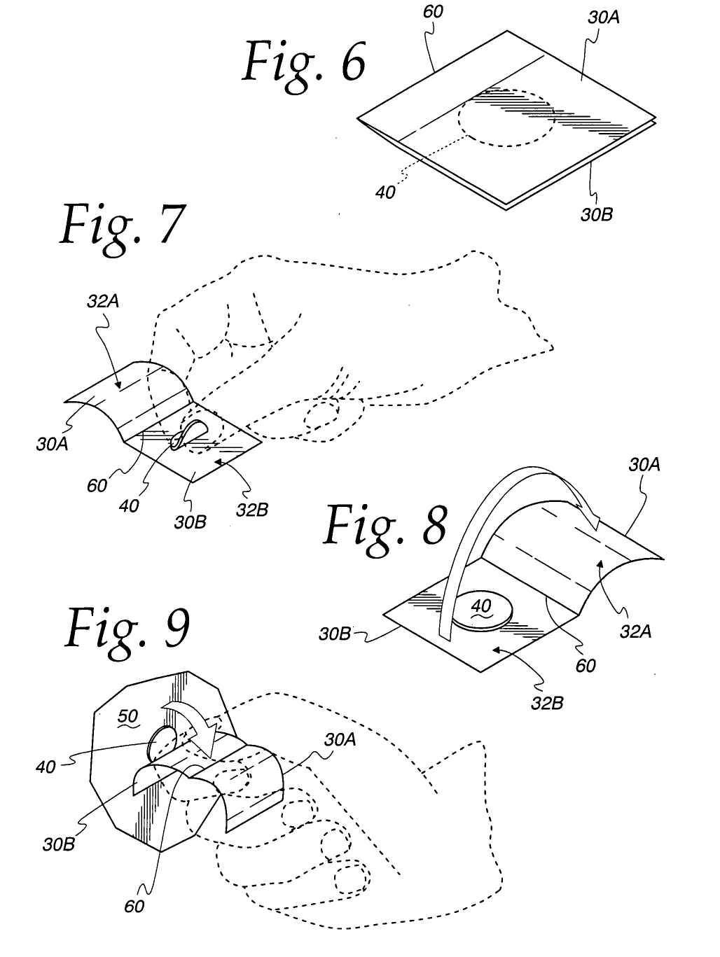

FIGS. 6-9 illustrate a modified embodiment of the present invention, wherein the two carrier members 30A, 30B are connected together at a fold 60, which embodiment clearly illustrates the ability to use a single elongated rectangular carrier with a release surface on only one side 32A, 32B. As illustrated in FIGS. 7 and 9, adhesive segments 40 on such carrier members 30A, 30B may be dispensed and applied in the same advantageous manner as the FIG. 1-5 embodiment.

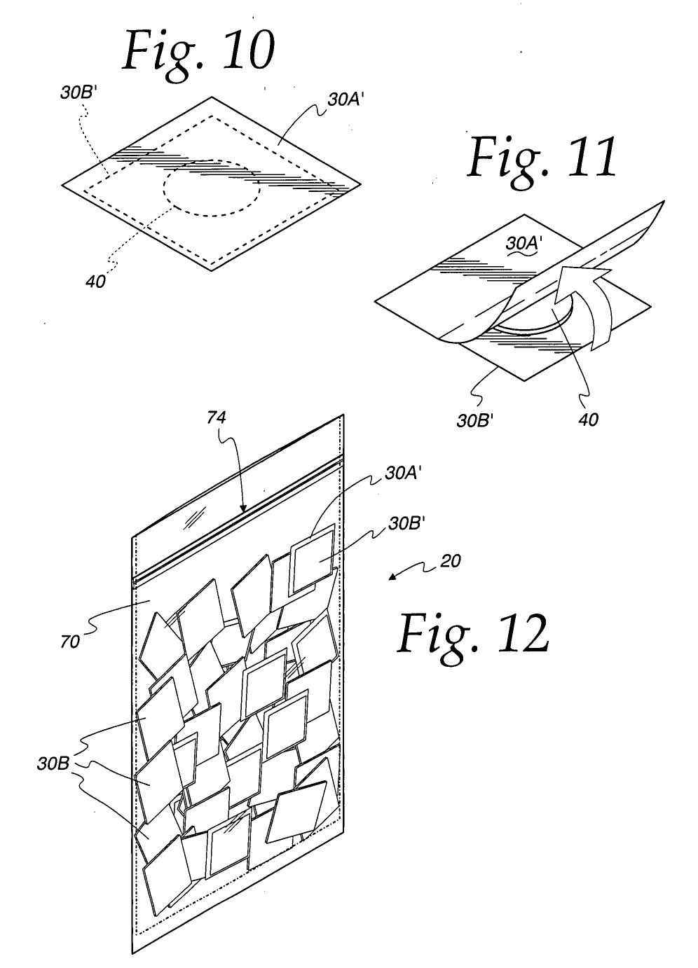

FIGS. 10-11 illustrate a third embodiment according to the present invention, wherein the two carrier members 30A′, 30B′ are secured to the adhesive segment 40 so that their perimeters do not match. This may be accomplished by simply not aligning the carrier members 30A′, 30B′, or it may be accomplished by using carrier members 30A′, 30B′ which are not the same size as each other. For example, the folded rectangular carrier members of FIGS. 6-9 could be folded along a line with is parallel to opposite sides of the single carrier but is closer to one side than the other. With this embodiment, the edges of the carrier members 30A′, 30B′ may be more easily separately grasped to bend them apart (see FIG. 11) to expose the adhesive segment 40.

FIG. 12 illustrates a full kit 20 according to the present invention wherein a closable container 70 includes a plurality of adhesive segments 40 on pairs of carrier members 30A, 30B such as disclosed above. As illustrated, the container 70 is transparent so that the contents can be seen even when closed, and includes a suitable resealable closure 74 at its opening. It should be appreciated, however, that virtually any closable container may be used with the present invention, so long as the container is suitable to reliably carry adhesive segments 40 protected by the container members 30A, 30B such as described above, and may be opened to access those adhesive segments 40 to dispense them for use when required.

Thus, it should be appreciated that with a kit 20 according to the present invention, a plurality of adhesive segments 40 may be provided for any suitable use, where the container 70 carries multiple adhesive segments 40 protected by the carrier members 30A, 30B, and the container 70 may be opened when desired to dispense required adhesive segments 40, which adhesive segments 40 may then be advantageously applied as described wherever required.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A kit of dispensable adhesive members, comprising
a plurality of carrier member pairs, wherein the carrier members of each pair each have a release surface on at least one side with at least one of said carrier members being flexible;
a plurality of segments having adhesive on opposite sides thereof, wherein each segment on its opposite sides is adhered to the release surfaces of a carrier member pair; and
a closable container carrying said plurality of carrier member pairs and plurality of segments, said container permitting selective dispensing of one segment and carrier member pair therefrom.

2. The kit of claim 1, wherein said carrier member pairs each comprise a single carrier having a release surface on one side and folded along a line whereby said one carrier member of said pair is said single carrier on one side of said fold line and the other carrier member of said pair is said single carrier on the other side of said fold line.

3. The kit of claim 2, wherein said fold line is spaced from a parallel center line of said single carrier.

4. The kit of claim 1, wherein one carrier member of a pair is larger than the other carrier member of the pair.

5. The kit of claim 1, wherein said container includes a resealable closure.

6. The kit of claim 1, wherein said segment is thermoplastic hot melt adhesive.

7. A kit of dispensable adhesive members, comprising
a plurality of carrier member pairs, wherein the carrier members of each pair each have a release surface on one side with at least one of said
carrier members being flexible, and have a width and a length, wherein one carrier member of said pair
has a different length or width than the other carrier member of said pair;
a plurality of segments having adhesive on opposite sides thereof, wherein each segment on its opposite sides is adhered to the release surfaces of a carrier member pair; and
a closable container carrying said plurality of carrier member pairs and plurality of segments, said container permitting selective dispensing of one segment and carrier member pair therefrom.

8. The kit of claim 7, wherein said carrier member pairs each comprise a single rectangular carrier having a release surface on one side and folded along a line whereby said one carrier member of said pair is said single carrier on one side of said fold line and the other carrier member of said pair is said single carrier on the other side of said fold line.

9. The kit of claim 8, wherein said single carrier is an elongated rectangle and said fold line is parallel to spaced opposite sides of said elongated rectangle, with said fold closer to one of said spaced opposite sides than to the other of said spaced opposite sides.

10. The kit of claim 7, wherein said container includes a resealable closure.

11. The kit of claim 7, wherein both of said carrier members of each pair are flexible.

12. The kit of claim 7, wherein said segment is thermoplastic hot melt adhesive.

13. The kit of claim 7, wherein said carrier members are rectangular.
